(19) United States
(12) Patent Application Publication
(10) Pub. No.: US 2025/0313292 A1
(43) Pub. Date: Oct. 9, 2025

(54) BICYCLE SUPPORT DEVICE

(71) Applicant: MONT’ID, Sainte Helene Du Lac (FR)

(72) Inventor: Yves LAGIER, Argonay (FR)

(73) Assignee: MONT’ID, Sainte Helene Du Lac (FR)

(21) Appl. No.: 19/172,298

(22) Filed: Apr. 7, 2025

(30) Foreign Application Priority Data
Apr. 8, 2024 (FR) 24 03605

(51) Int. Cl. B62H 3/08

(52) U.S. Cl. CPC B62H 3/08

(57) ABSTRACT

A support device receiving and retaining a bicycle on a mechanical lift vehicle moved in a longitudinal direction, the support device including: a lower support with an intermediate receptacle receiving in bearing engagement a wheel of said cycle extending between a proximal end section and a distal end section and articulated by its proximal end section to pivot between: a transport position in which the lower support is at a first angle to the longitudinal direction, a loading position in which the lower support is at a second angle less than the first angle, rolling means on the distal end section of the lower support conformed to roll on a surface such as the ground.

### BACKGROUND

The present invention concerns the cycle transport field and more particularly concerns a support device to receive and to retain a bicycle on the back or on the side of a mechanical lift vehicle.

There is known from the document WO 2011/101785 A1 a support device to receive and retain a bicycle on the back of a mechanical lift vehicle intended to be moved in a longitudinal direction, said support device including a support conformed to receive and to retain a first wheel (front wheel) of said bicycle oriented in a substantially vertical retaining plane containing said longitudinal direction.

Such a support device must not be installed too high on the mechanical lift vehicle in order to allow said mechanical lift vehicle to oscillate from front to back (for example because of wind) by an angle of approximately 40 degrees (20 degrees toward the front and 20 degrees toward the back) without the support device striking a cable or a part of a pylon of the mechanical lift system. As a result of this, the height-wise disposition of the support device on the mechanical lift vehicle is often low and frequently causes contact of the second wheel (rear wheel) with the ground of the departure and/or arrival station.

When the mechanical lift vehicle reaches the arrival station, it sometimes suffers a small rearward movement. A first disadvantage of this is that this rearward movement can cause stresses (notably torsion stresses) in the second wheel, possibly to the point of causing the latter to buckle.

The trajectory of the mechanical lift vehicle in the departure or arrival station includes a substantially semicircular portion enabling the mechanical lift vehicle to depart in the opposite direction. During all or part of this circular trajectory of the mechanical lift vehicle the second wheel (rear wheel) generally comes into contact with the ground but does not roll perfectly on the ground: the wheel is in fact driven to skid laterally on the ground over at least a part of its trajectory on the ground. This lateral skidding movement tends to orient the cycle obliquely relative to the retaining plane. A second drawback is that stresses (notably torsion stresses) are then produced on the first wheel (front wheel) via the support, which stresses can cause the first wheel to buckle and impede extraction of the first wheel from the support (and therefore unloading of the cycle).

The document FR 2 958 255 A1 describes a support device conforming to the preamble of claim 1, comprising:
an upper support conformed to receive and retain a first wheel of said bicycle,
a lower support including an intermediate receptacle to receive in bearing engagement a second wheel of said bicycle.

A support device of this kind must not strike the ground in a departure or arrival station and is therefore installed very high on the mechanical lift vehicle. The mechanical lift vehicle is then not able to oscillate from front to rear (for example because of the effect of wind) with a satisfactory angular amplitude (approximately 20 degrees toward the front and approximately 20 degrees toward the rear) without the support device striking a cable or a part of a pylon of the mechanical lift vehicle system.

### SUMMARY

The terms “front”, “rear”, “anterior” and “posterior” are used hereinafter to define the position of one element relative to another as a function of a direction of movement, for example the direction of movement of a mechanical lift vehicle or a bike during normal use thereof.

The terms “high”, “low”, “upper” and “lower” are used hereinafter to define the position of one element relative to another as a function of their height in a vertical direction defined by terrestrial gravity.

One problem addressed by the present invention is to limit the risks of the cycle (notably its wheels) being damaged by contact thereof with the ground in a departure and/or arrival station.

Another problem addressed by the invention is facilitating loading and offloading the cycle in departure and arrival stations.

Another problem addressed by the invention is allowing oscillation of the mechanical lift vehicle from front to rear (for example because of the effect of wind) with a satisfactory angular amplitude (approximately 20 degrees toward the front and approximately 20 degrees toward the rear) without the support device striking a cable or a part of a pylon of the mechanical lift system.

To achieve the above and other objects, the invention proposes a support device for receiving and retaining a bicycle on the back and/or on the side of a mechanical lift vehicle intended to be moved in a longitudinal direction, said support device comprising an upper support conformed to receive and retain a first wheel of said bicycle oriented in a substantially vertical retaining plane containing said longitudinal direction, said support device including:
a lower support extending lengthwise between a proximal end section and a distal end section,
an intermediate receptacle on said lower support between the proximal end section and the distal end section conformed to receive in bearing engagement a second wheel of said bicycle, According to the invention:
the proximal end section of the lower support is articulated to pivot in said retaining plane between:
a. a transport position in which the lower support (5) is at a first angle (A1) to the longitudinal direction (I-I),
b. a loading position in which the lower support (5) is at a second angle (A2) to the longitudinal direction (I-I), the second angle (A2) being less than the first angle (A1),
rolling means (7) are arranged on the distal end section (5b) of the lower support (5) and conformed to roll on a surface such as the ground (S).

The second wheel of the cycle is supported at all times by the lower support and therefore does not come into contact with the ground. In a departure or arrival station the lower support is able to pivot on coming into contact with the ground and remains in contact with the ground via the rolling means, which enable rolling on the ground in a way that does not stress the cycle.

To obtain a simple and robust structure the lower support can preferably have its proximal end section articulated to the upper support.

First abutment means advantageously oppose downward rotation of the lower support beyond a predetermined limit oblique orientation in which the second wheel is behind the first wheel in the direction of movement of the mechanical lift vehicle. Such a limit oblique orientation makes it possible to hold the second wheel in bearing engagement in the intermediate receptacle merely by the effect of gravity. Such an oblique orientation also makes it possible to limit the risk of conflict with the guardrail of the mechanical lift vehicle if the latter is of the seat type.

The rolling means can preferably be conformed to roll in all directions in a plane. The lateral stresses on the support device and its components are therefore very limited or even non-existent, even in movement in a turn.

To this end the rolling means can advantageously include a castor carried by a mount pivoting freely about a pivot axis. Such a castor is sometimes termed an “idler castor”. Alternatively, the rolling means can include one or more supporting balls.

For improved retention of the bicycle the intermediate receptacle can advantageously be conformed to hold said second wheel substantially in said retaining plane.

To improve reception and retention of the second wheel the intermediate receptacle can preferably have a cross section in said retaining plane that is substantially U-shaped or V-shaped.

The upper support can advantageously include a lower retaining element intended to receive said first wheel in vertical bearing engagement. The cycle can therefore rest in the upper support merely by the effect of gravity. Preferably:
the upper support includes an upper retaining element intended to come to bear vertically on said first wheel,
the upper retaining element is articulated so as to pivot in said retaining plane relative to the lower retaining device between:
a. at least one open position in which the first wheel can penetrate between the upper retaining element and the lower retaining element by a forward introduction movement in said retaining plane,
b. at least one closed position in which the upper retaining element and the lower retaining element oppose extraction of the first wheel by a rearward extraction movement in said retaining plane.

The cooperation of the upper and lower retaining elements enables reliable retention of the wheel in the upper support.

The first elastic return means disposed between the upper retaining element and the lower retaining element can advantageously urge the upper retaining element and the lower retaining element at all times toward their closed position. The first elastic return means enable a force to be exerted that is sufficiently high to limit the risk of the first wheel escaping accidentally from the upper support in departure and arrival stations but sufficiently low to enable an operator to take hold of the first wheel in the upper support in departure and arrival stations without too much trouble.

Preferably:
the upper retaining element can be connected to the lower support by second elastic return means,
pivoting of the lower support toward its transport position brings about lengthening of the second elastic return means whatever the position of the upper retaining element.

The second elastic return means enable much better retention of the first wheel in the upper support when the mechanical lift vehicle is not in a departure or arrival station, that is to say when the lower support is in a transport position: this effectively limits the risks of the cycle falling off, even in a high wind. On the other hand, when the mechanical lift vehicle is in a departure station the lower support is pivoted into a loading position by the rolling means pressing on the ground, with the result that the second elastic return means are relaxed and do not impede the introduction of the first wheel into the upper support. When the mechanical lift vehicles is in an arrival station the lower support is pivoted into a loading position by the rolling means bearing on the ground with the result that the second elastic return means are relaxed and do not impede the extraction of the first wheel from the upper support.

The first elastic return means and/or the second elastic return means can advantageously include a spring or a sandow. Such elastic return means are simple, economical and robust.

Alternatively:
the first elastic return means and/or the second elastic return means can include a connecting rod including a body the length of which can vary between a first length and a second length greater than the first length,
the body of the connecting rod includes a first body section and a second body section arranged in a telescopic manner,
a spring exerts at all times a force tending to return the body of the connecting rod to its first length.

The support device preferably includes second abutment means opposing pivoting of the upper retaining element toward the lower retaining element beyond a predetermined waiting position. The waiting position is chosen so as to produce an offset between the upper retaining element and the lower retaining element that is large enough for the first wheel of the cycle to be engaged easily and small enough to ensure satisfactory retention of relatively small diameter first wheels of cycles.

Advantageously:
the upper retaining element can include two lateral arms spaced apart from one another on respective opposite sides of the retaining plane so as to receive between them a part of the first wheel, said lateral arms each having a free end,
the free ends of the lateral arms are connected to one another by connecting means intended to come to bear vertically on the first wheel.

The lateral arms participate in orienting and retaining the first wheel in the retaining plane while allowing the connecting means to come to bear vertically on the first wheel so as to improve its retention in the upper support.

The connecting means can preferably include a roller pivoting about a transverse axis substantially perpendicular to said retaining plane. The pivoting of the roller makes it possible to facilitate the introduction of the first wheel into the upper support between the upper retaining element and the lower retaining element.

The support device can advantageously include locking means conformed to fix the support device to the back of a mechanical lift vehicle having a width in a transverse direction, said mechanical lift vehicle being intended to be moved in the longitudinal direction.

The support device can therefore easily be mounted on and fixed to a mechanical lift vehicle, in particular onto an existing mechanical lift vehicle.

In accordance with another aspect of the present invention there is proposed a mechanical lift vehicle having a width in a transverse direction and intended to be moved in a longitudinal direction, including a support device as described above, said support device being fixed to the back of the mechanical lift vehicle.

Alternatively, the support device as described above can be fixed to the side of the mechanical lift vehicle.

In accordance with a yet further aspect of the present invention there is proposed a mechanical lift system including at least one mechanical lift vehicle as described above, said mechanical lift vehicle being of the chair or cabin type.

### BRIEF DESCRIPTION OF THE DRAWINGS

Other objects, features and advantages of the present invention will emerge from the following description of particular embodiments given with reference to the appended figures in which:

FIG. 1 is a side view as seen in a first direction of a support device in accordance with one particular embodiment of the invention with a lower support disposed in a transport position;

FIG. 2 is a perspective view of the support device from FIG. 1;

FIG. 3 is a side view of the support device from FIG. 1 as seen in a second direction opposite the first direction;

FIG. 4 is a side view of the support device from FIG. 1 as seen in the first direction with the lower support in a loading position;

FIG. 5 is a perspective view of the support device from FIG. 4;

FIG. 6 is a schematic partial view in section of an example of elastic return means that can be used in the context of the present invention;

FIG. 7 is a side view of a mechanical lift vehicle carrying a support device from FIG. 1 with a cycle at a first stage of loading;

FIG. 8 is a side view of the mechanical lift vehicle from FIG. 7 with the cycle at a second stage of loading;

FIG. 9 is a side view of the mechanical lift vehicle from FIG. 7 with the cycle at a third stage of loading;

FIG. 10 is a side view of the mechanical lift vehicle from FIG. 7 with the support device carrying the cycle and with the lower support in the transport position;

FIG. 11 is a perspective view of a mechanical lift vehicle carrying two support devices from FIG. 1, one of which is carrying a cycle, said mechanical lift vehicle being in a departure or arrival station of the mechanical lift; and

FIG. 12 is a perspective view of the mechanical lift vehicle from FIG. 11 located between departure and arrival stations of a mechanical lift system.

### DETAILED DESCRIPTION

When identical reference numbers are used in more than one figure, embodiment or variant of the invention they designate identical or similar elements in each of the figures, embodiments or variants.

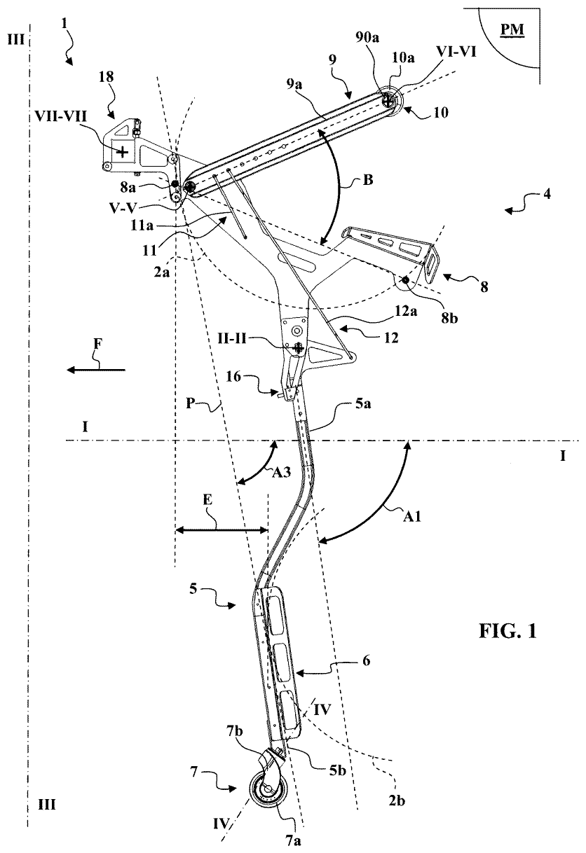

A support device 1 in accordance with one particular embodiment of the invention is depicted in FIGS. 1 to 5.

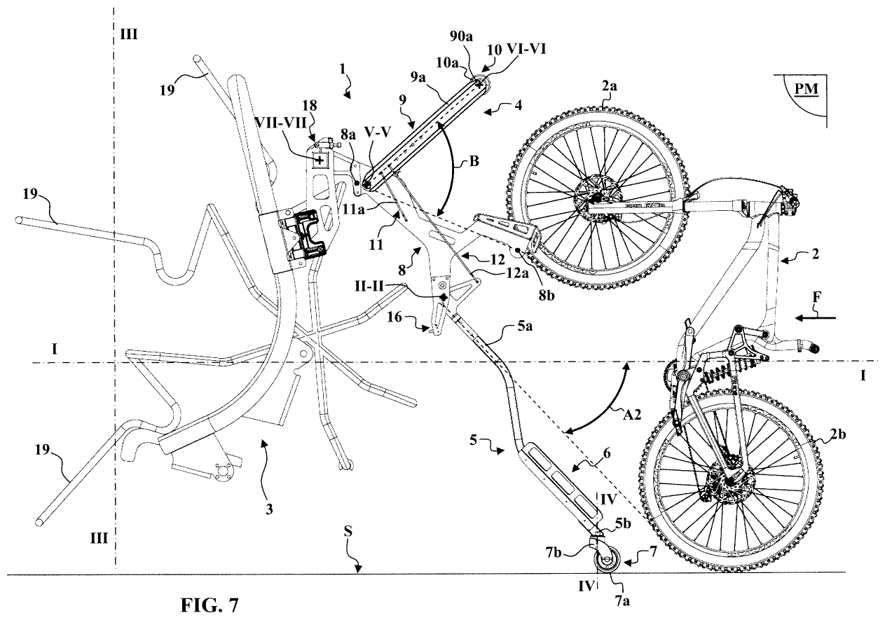

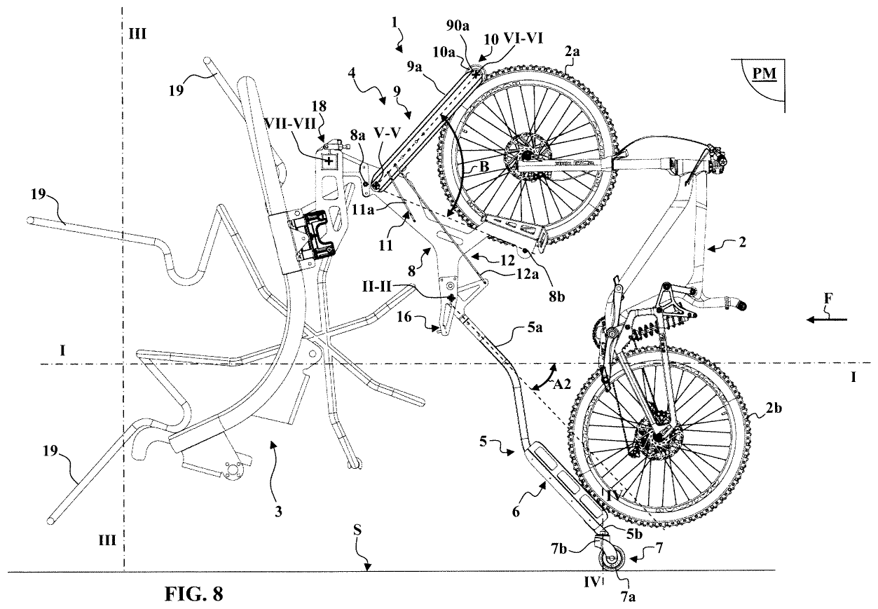

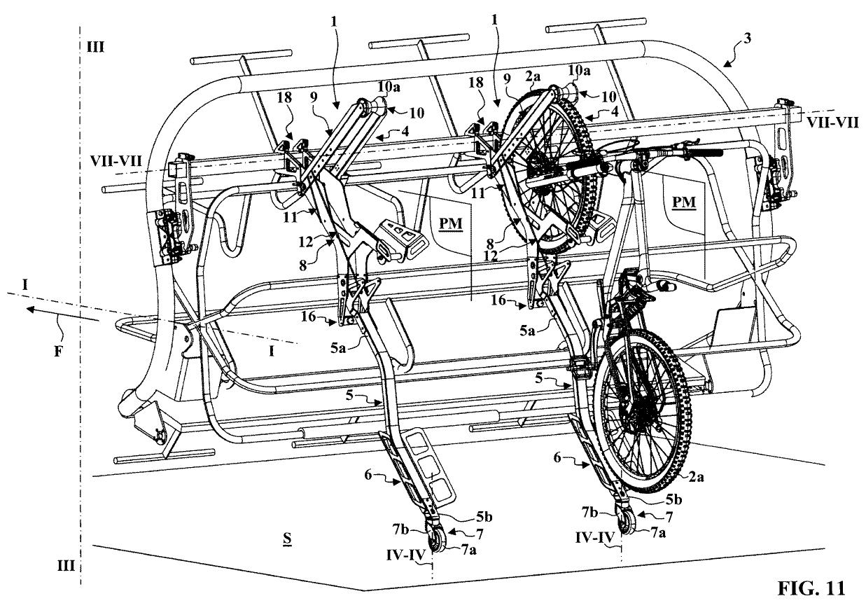

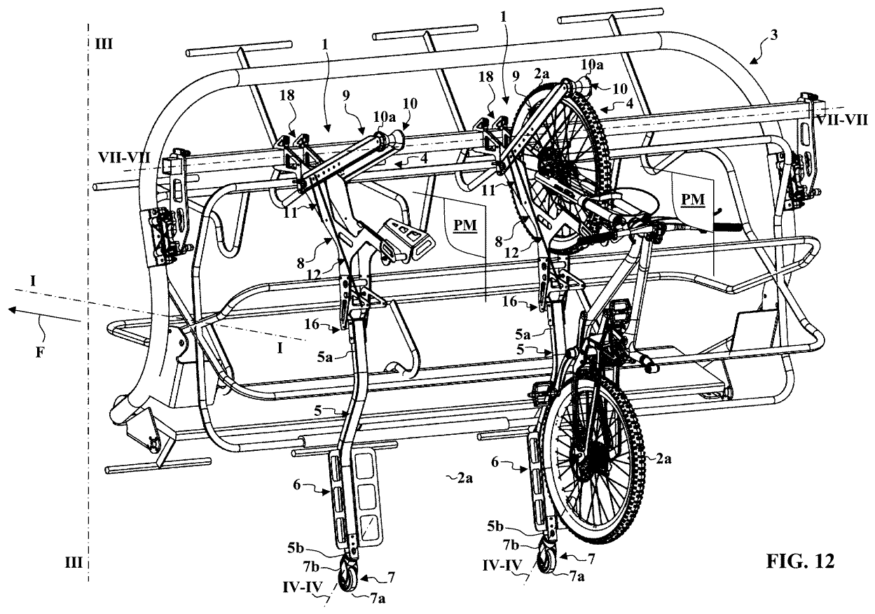

This support device 1 is intended to receive and retain a cycle 2 with two wheels 2a (first wheel) and 2b (second wheel) disposed on the back and/or on the side of a mechanical lift vehicle 3, said mechanical lift vehicle 3 being intended to be moved in a longitudinal direction I-I (FIGS. 7 to 12) in the sense indicated by the arrow F.

The mechanical lift vehicle 3 has a width in a direction VII-VII transverse to the longitudinal direction I-I.

The support device 1 includes locking means 18 conformed to fix the support device 1 to the back of the mechanical lift vehicle 3 (FIGS. 7 to 12) relative to a direction of forward movement indicated by the arrow F.

As can be seen in FIGS. 1 to 5 in particular the support device 1 comprises an upper support 4 conformed to receive and retain the first wheel 2a of said bicycle 2 oriented in a substantially vertical retaining plane PM containing said longitudinal direction I-I (the retaining plane PM is also substantially perpendicular to the transverse direction VII-VII).

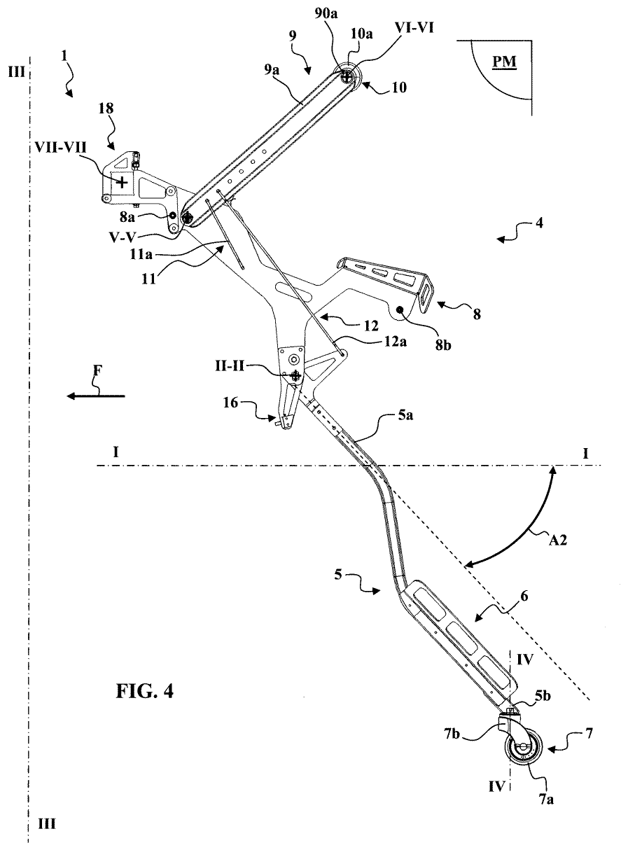

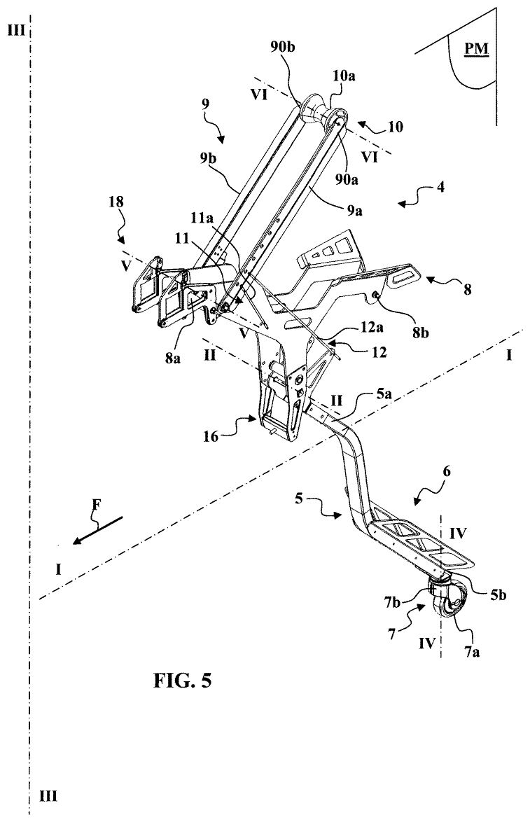

The support device 1 further includes:
a lower support 5 extending between a proximal end section 5a and a distal end section 5b and with its proximal end section 5a articulated to pivot in said retaining plane PM between:
a. a transport position (FIGS. 1 to 3) in which the lower support 5 is at a first acute angle A1 to the longitudinal direction I-I,
b. a loading position (FIGS. 4 and 5) in which the lower support 5 is at a second acute angle A2 to the longitudinal direction I-I, the second angle A2 being less than the first angle A1,
an intermediate receptacle 6 arranged on said lower support 5 between the proximal end section 5a and the distal end section 5b and conformed to receive in bearing engagement the second wheel 2b of said bicycle 2,
rolling means 7 on the distal end section 5b of the lower support 5 conformed to roll on a surface such as the ground S (FIGS. 7 to 9 and 11).

To be more precise, here the lower support 5 is articulated by its proximal end section 5a to the upper support 4, pivoting about an axis II-II perpendicular to the retaining plane PM. The upper support 4 is intended to be placed in a higher position than the lower support 5 when the mechanical lift vehicle 3 is in use.

First abutment means 16 oppose downward rotation of the lower support 5 beyond a predetermined limit oblique orientation (depicted in FIGS. 1 to 3). In this predetermined limit oblique orientation the second wheel 2b is behind the first wheel 2a in the longitudinal direction I-I (the forward sense being that defined by the arrow F). The bicycle 2 is therefore retained on the support device 1 at all times at a slope P indicated by the third angle A3 in FIG. 1. This slope P makes it possible to hold the second wheel 2b at all times pressed against the intermediate receptacle 6 merely by the effect of gravity (here in a vertical direction III-III).

Furthermore, the predetermined limit oblique orientation enables the guard rail 19 of the mechanical lift vehicle 3 to function with no interference with the support device 1. This absence of interference is shown in FIGS. 7 to 12 in which the guard rail 19 is depicted in three positions (a closed position, an open position and an intermediate position between the open and closed positions): whatever its position, the guard rail 19 never collides with the support device 1 between its open and closed positions.

The rolling means 7 are conformed to roll in all directions in a plane. To this end the rolling means 7 here include a castor 7a carried by a mount 7b pivoting freely about a pivot axis IV-IV.

The intermediate receptacle 6 can be flat; the rubbing of the tire on the intermediate receptacle 6 can be sufficient to retain the second wheel 2b substantially in the retaining plane PM. A textured flat intermediate receptacle 6 can contribute to retaining it by increasing the friction on the tire of the second wheel 2b.

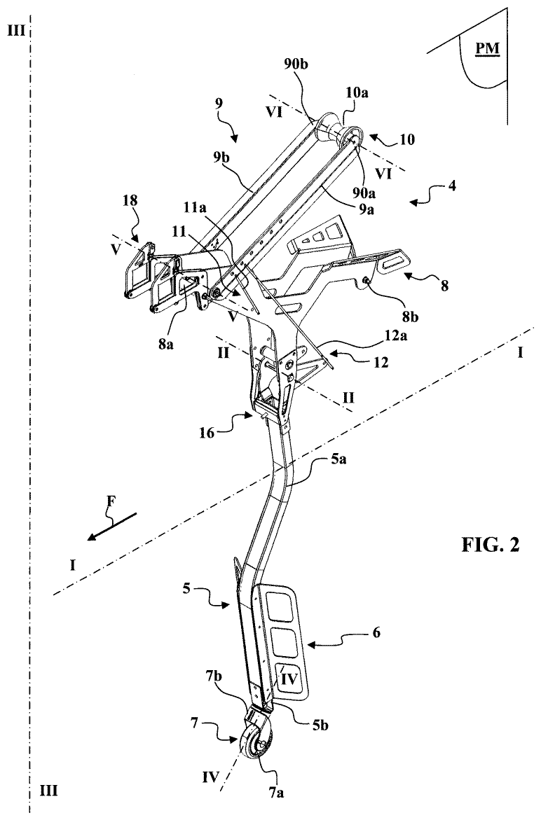

For improved retention of the second wheel 2b in the retaining plane PM the intermediate receptacle 6 here has a cross section in said retaining plane PM that is substantially U-shaped or V-shaped (FIGS. 2 and 5).

The upper support 4 includes a lower retaining element 8 intended to receive said first wheel 2a in vertical bearing engagement. In this instance the lower retaining element 8 receives the first wheel 2a in vertical bearing engagement against two transverse rods 8a and 8b oriented substantially perpendicularly to the retaining plane PM.

In the embodiment depicted in the figures the upper support 4 further includes an upper retaining element 9 intended to come to bear vertically downward on said first wheel 2a.

The upper retaining element 9 includes two lateral arms 9a and 9b spaced from one another on respective opposite sides of said retaining plane PM so as to be able to receive a part of the first wheel 2a between them. The lateral arms 9a and 9b each have a free end 90a and 90b. The free ends 90a and 90b of the lateral arms 9a and 9b are connected to one another by connecting means 10 intended to come to bear vertically downward on the first wheel 2a.

Here the connecting means 10 include a roller 10a (of diabolo shape with two frustoconical sections joined at their apex) disposed to pivot about a transverse axis VI-VI substantially perpendicular to said retaining plane PM.

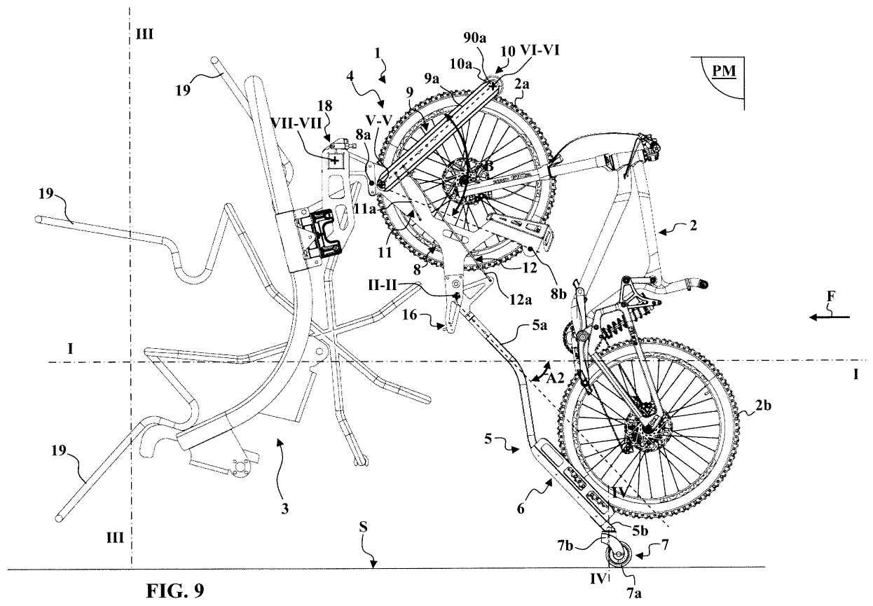

The upper retaining element 9 is articulated so as to pivot in said retaining plane PM (about an axis V-V) relative to the lower retaining element 8 between:
at least one open position in which the first wheel 2a can penetrate between the upper retaining element 9 and the lower retaining element 8 by a forward introduction movement in said retaining plane PM,
at least one closed position (depicted in FIG. 9) in which the upper retaining element 9 and the lower retaining element 8 oppose extraction of the first wheel 2a by a rearward extraction movement (in the sense opposite to that indicated by the arrow F) in said retaining plane PM.

The upper retaining element 9 is at an angle B to the lower retaining element 8 defining the degree of opening of the upper support 4. The angle B is between on the one hand the straight-line segment passing through the axis V-V and the transverse axis VI-VI and on the other hand the straight-line segment passing through the two transverse rods 8a and 8b.

In practice the upper retaining element 9 is in the open position when the roller 10a of the connecting means 10 is spaced from the rod 8b of the lower retaining element 8 by a distance equal to the outside diameter of the first wheel 2a.

First elastic return means 11 between the upper retaining element 9 and the lower retaining element 8 urge the upper retaining element 9 and the lower retaining element 8 toward their closed position at all times.

Here the upper retaining element 9 is also connected to the lower support 5 by second elastic return means 12 tending to cause the upper retaining element 9 to pivot toward its closed position. The second elastic return means 12 are arranged so that pivoting of the lower support 5 toward its transport position (FIGS. 1 to 3) causes lengthening of the second elastic return means 12 whatever the position of the upper retaining element 9 and increases the force urging the upper retaining element 9 toward its closed position. This elongation can notably be seen by comparing FIGS. 1 and 4.

In FIGS. 1 to 5 and 7 to 12 the first elastic return means 11 and the second elastic return means 12 include respective sandows 11a and 12a. Coil springs could be used instead, however.

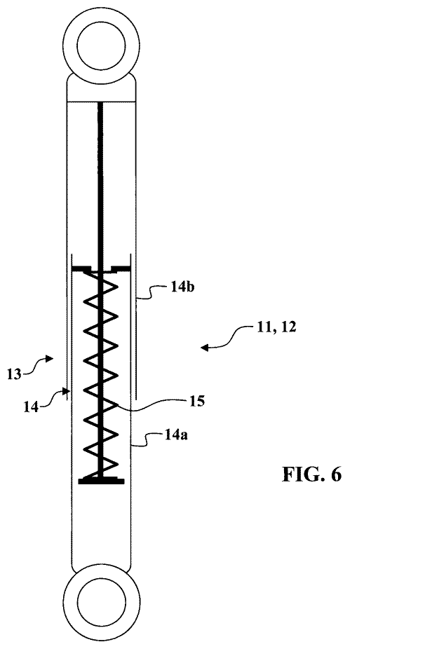

In another alternative depicted in FIG. 6:
the first elastic return means 11 and/or the second elastic return means 12 include(s) a connecting rod 13 including a body 14 the length of which can vary between a first length and a second length greater than the first length,
the body 14 of the connecting rod 13 includes a first body section 14a and a second body section 14b arranged in a telescopic manner,
a spring 15 exerts at all times a force tending to return the body 14 of the connecting rod 13 to its first (shorter) length.

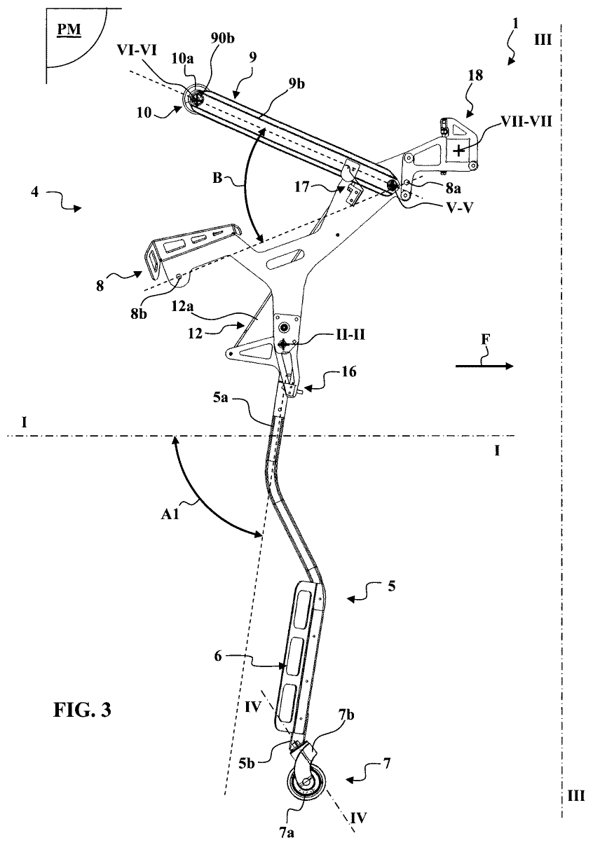

It is seen specifically in FIG. 3 that the support device 1 includes second abutment means 17 opposing pivoting of the upper retaining element 9 toward the lower retaining element 8 beyond a predetermined waiting position that is depicted in FIGS. 1 to 3.

In the waiting position the upper retaining element 9 is at the smaller angle B to the rods 8a and 8b of the lower retaining element 8. This smaller angle B is chosen to procure an offset between the upper retaining element 9 and the lower retaining element 8 that is large enough for a user to be able easily to introduce the first wheel 2a of the cycle 2 (the first wheel 2a then pushing the upper retaining element 9 upward) and small enough to achieve satisfactory retention of relatively small diameter first wheels 2a of cycles 2.

The functioning of the support device 1 will now be explained in more detail by means of FIGS. 7 to 12, which depict successive steps performed in a departure station of a ski lift type mechanical lift.

During a first step depicted in FIG. 7 the support device 1 is located in the loading position because the lower support 5 is in rolling bearing engagement with the ground S via the rolling means 7.

To load a cycle 2 an operator orients said cycle 2 in the retaining plane PM by lifting its first (front) wheel 2a and holding it with its second (rear) wheel 2b resting on the ground S. The operator then moves the cycle 2 toward the support device 1 by a forward movement (that is to say a movement in the sense defined by the arrow F) relative to the mechanical lift vehicle 3 (here a ski lift chair).

The front wheel (first wheel) 2a then comes firstly to bear on the transverse rod 8b.

The operator continues to push the cycle 2 toward the support device 1 by a forward movement of the cycle 2 (that is to say a movement in the sense defined by the arrow F) relative to the mechanical lift vehicle 3: the first (front) wheel 2 passes over the transverse rod 8b.

The passage over the rod 8b causes the second (rear) wheel 2b to lift off the ground S and the second (rear) wheel 2b comes to be engaged in the intermediate receptacle 6 of the lower support 5.

The operator continues pushing until the first (front) wheel 2a comes to bear against the transverse rod 8a to complete the penetration of the first (front) wheel 2a into the upper support 4.

During the introduction of the first (front) wheel 2a into the upper support 4 there first occurs an opening movement of the upper support 4 followed by a closing movement of the upper support 4.

During the opening movement of the upper support 4 the upper retaining element 9 is moved by the first wheel 2a from its waiting position (FIG. 7) in which the distance between the roller 10a and the transverse rod 8b is less than the outside diameter of the first (front) wheel 2a (the angle B is then minimal) to an open position in which the first (front) wheel 2a is able to penetrate between the upper retaining element 9 and the lower retaining element 8 (the distance between the roller 10a and the transverse rod 8b is then substantially equal to the outside diameter of the first (front) wheel 2a and the angle B is then maximal). The opening movement of the upper support 4 is brought about by the first (front) wheel 2a pushing the upper retaining element 9 away from the lower retaining element 8 against the action of the first elastic return means 11 (and also against the action of the second elastic return means 12).

During the closing movement of the upper support 4 the upper retaining element 9 is moved from its open position to a closed position (FIG. 9) in which the upper retaining element 9 and the lower retaining element 8 oppose extraction of the first wheel 2a by a rearward extraction movement in said retaining plane PM (in the sense opposite that indicated by the arrow F). This opposition is the result of the distance between the roller 10a and the transverse rod 8b, which is less than the outside diameter of the first (front) wheel 2a. Here, in the closed position the angle B is chosen to be between the (minimal) angle B of the waiting position and the (maximal) angle B of the open position. The closing movement of the upper support 4 is brought about by the first elastic return means 11 that urge the upper retaining element 9 at all times to pivot toward the lower retaining element 8. The second elastic return means 12 also participate in this pivoting return movement of the upper retaining element 9.

In the closed position the first elastic return means 11 (and the second elastic return means 12) exert a first vertical retaining force on the first (front) wheel 2a that makes it possible to limit effectively the risks of untimely escape of the first (front) wheel 2a from the upper support 4 during forward movement of the mechanical lift vehicle 3 in a station.

Once the cycle 2 has reached the FIG. 9 position it is retained and oriented (by its wheels 2a and 2b) in a substantially vertical retaining plane PM containing said longitudinal direction I-I.

The rolling means 7 support the lower support 5 and enable it to move over the ground S (which is flat here) in all directions parallel to said plane of the ground S by virtue of the castor 7a pivoting about the pivot axis IV-IV. If the ground S is not strictly flat the castor 7a remains in contact with the ground S by virtue of the lower support 5 pivoting about the axis II-II perpendicular to the retaining plane PM. Thus no stress is exerted on the cycle 2 by the relative movement of the mechanical lift system 3 relative to the ground S.

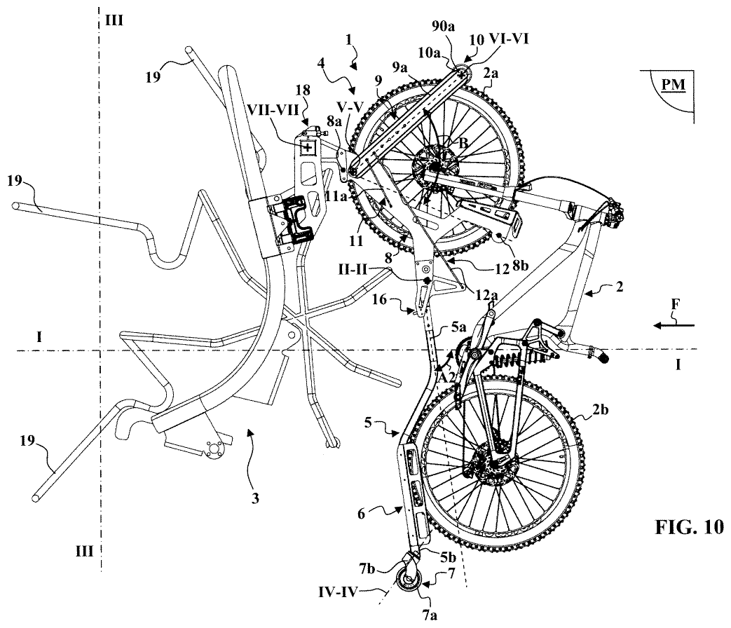

When the mechanical lift vehicle 3 leaves the mechanical lift departure station its distance E relative to the ground S increases: the lower support 5 then no longer rests on the ground S and can therefore pivot toward its transport position (depicted in FIG. 10) merely by the effect of gravity. The lower support 5 is then retained in its predetermined limit oblique orientation determined by the first abutment means 16.

The first abutment means 16 oppose downward rotation of the lower support 5 beyond the predetermined limit oblique orientation in which the second wheel 2b is to the rear of the first wheel 2a at a distance E (in the longitudinal direction I-I). The second (rear) wheel 2b is therefore kept pressed against the lower support 5 and in the receptacle 6 merely by the effect of gravity.

The tilting of the lower support 5 from its loading position to its transport position causes lengthening of the second elastic return means 12, the effect of which is to generate a second vertical retaining force on the first (front) wheel 2a that is greater than the first vertical retaining force. The first (front) wheel 2a is therefore even better held captive in the lower retaining element 8 and the upper retaining element 9 when the mechanical lift vehicle 3 is at a greater height relative to the ground S.

When the mechanical lift vehicle 3 enters an arrival station the lower support 5 comes into contact with the ground S via the rolling means 7: the lower support 5 then swings from its transport position to its loading position (which in this case has become an unloading position) as depicted in FIG. 9. Note that in the arrival station the lower support 5 can pivot about the axis V-V by an angle greater or smaller than the angle that the lower support 5 assumes in a departure station, as a function of the relative distance in height between the mechanical lift vehicle 3 and the ground S.

Once again, the rolling means 7 make it possible to follow the movement induced between the support device 1 and the ground S by the trajectory of the mechanical lift vehicle 3 (which can be at least in part circular): there is no longer the problem of lateral skidding of the cycle 2 on the ground S when it is carried with its second wheel 2b in the lower support 5, the castor 7a of which (sometimes termed an “idler castor”) rolls on the ground, being freely oriented about its pivot axis IV-IV (which is substantially vertical).

Starting from the position depicted in FIG. 9 an operator present in the arrival station can extract the cycle 2 by a rearward movement of the cycle 2 relative to the mechanical lift vehicle 3. Doing this, they cause the first (front) wheel 2a to escape from the upper support 4.

Note that at this moment the second elastic return means 12 are less taut than in the transport position: the first (front) wheel 2a is substantially held captive by the first vertical retaining force, which is lower than the second vertical retaining force. The operator can therefore extract the cycle 2 from the upper support 4 relatively easily.

To extract the first (front) wheel 2a from the upper support 4 the upper retaining element 9 is firstly pushed by the first wheel 2a away from the lower retaining element 8 from its closed position (intermediate angle B) to its open position (maximal angle B). Then, after extraction of the first wheel 2a the upper retaining element 9 secondly pivots back toward the lower retaining element 8 from its open position toward its waiting position (minimal angle B), being urged by the first elastic return means 11.

Although the support device 1 according to the present invention has been described above as being fixed to the back of the mechanical lift vehicle 3 it is possible for the support device 1 to be fixed to the side of the mechanical lift vehicle 3.

Although the support device 1 according to the present invention has been described above in the context of use on a chair-type mechanical lift vehicle 3 the mechanical lift vehicle 3 can be a cabin.

The present invention is not limited to the embodiments that have been explicitly described but includes diverse variants and generalizations thereof within the scope of the following claims.

1. A support device for receiving and retaining a cycle with two wheels on the back or on the side of a mechanical lift vehicle intended to be moved in a longitudinal direction, said support device comprising an upper support conformed to receive and retain a first wheel of said cycle with two wheels oriented in a substantially vertical retaining plane (PM) containing said longitudinal direction, said support device including:
a lower support extending lengthwise between a proximal end section and a distal end section,
an intermediate receptacle on said lower support between the proximal end section and the distal end section conformed to receive in bearing engagement a second wheel of said cycle with two wheels,
wherein:
the proximal end section of the lower support is articulated to pivot in said retaining plane (PM) between:
a. a transport position in which the lower support is at a first angle (A1) to the longitudinal direction,
b. a loading position in which the lower support is at a second angle (A2) to the longitudinal direction, the second angle (A2) being less than the first angle (A1),
rolling means on the distal end section of the lower support conformed to roll on a surface such as the ground(S).

2. The support device as claimed in claim 1 wherein the proximal end section of the lower support is articulated to the upper support.

3. The support device as claimed in claim 1 wherein first abutment means oppose downward rotation of the lower support beyond a predetermined limit oblique orientation in which the second wheel is behind the first wheel.

4. The support device as claimed in claim 1 wherein the rolling means are conformed to roll in any direction in a plane.

5. The support device as claimed in claim 4, wherein the rolling means include a castor carried by a mount pivoting freely about a pivot axis (IV-IV).

6. The support device as claimed in claim 1 wherein the intermediate receptacle is conformed to retain said second wheel in said retaining plane (PM) and preferably has a cross section in said retaining plane (PM) that is substantially U-shaped or V-shaped.

7. The support device as claimed in claim 1 wherein the upper support includes a lower retaining element intended to receive said first wheel in vertical bearing engagement.

8. The support device as claimed in claim 7 wherein:
the upper support includes an upper retaining element intended to come to bear vertically on said first wheel,
the upper retaining element is articulated so as to pivot in said retaining plane (PM) relative to the lower retaining device between:
a. at least one open position in which the first wheel can penetrate between the upper retaining element and the lower retaining element by a forward introduction movement in said retaining plane (PM),
b. at least one closed position in which the upper retaining element and the lower retaining element oppose extraction of the first wheel by a rearward extraction movement in said retaining plane (PM).

9. The support device as claimed in claim 8 wherein first elastic return means between the upper retaining element and the lower retaining element urge the upper retaining element and the lower retaining element at all times toward their closed position.

10. The support device as claimed in claim 8 wherein:
the upper retaining element is connected to the lower support by second elastic return means,
pivoting of the lower support toward its transport position brings about lengthening of the second elastic return means whatever the position of the upper retaining element.

11. The support device as claimed in claim 9 wherein the first elastic return means and/or the second elastic return means include(s) a spring or a sandow.

12. The support device as claimed in claim 9 wherein:
the first elastic return means and/or the second elastic return means include(s) a connecting rod including a body the length of which can vary between a first length and a second length greater than the first length,
the body of the connecting rod includes a first body section and a second body section arranged in a telescopic manner,
a spring exerts at all times a force tending to return the body of the connecting rod to its first length.

13. The support device as claimed in claim 8 wherein the support device includes second abutment means opposing pivoting of the upper retaining element toward the lower retaining element beyond a predetermined waiting position.

14. The support device as claimed in claim 8, wherein:
the upper retaining element includes two lateral arms spaced from one another and on respective opposite sides of the retaining plane (PM) so as to receive between them a part of the first wheel, said lateral arms each having a free end,
the free ends of the lateral arms are connected to one another by connecting means intended to come to bear vertically on the first wheel.

15. The support device as claimed in claim 14, wherein the connecting means include a castor disposed to pivot about a transverse axis (VI-VI) substantially perpendicular to said retaining plane (PM).

16. The support device as claimed in claim 1 including locking means conformed to fix the support device to the back of a mechanical lift vehicle having a width in a transverse direction (VII-VII), said mechanical lift vehicle being intended to be moved in the longitudinal direction.

17. A mechanical lift vehicle having a width in a transverse direction (VII-VII) and intended to be moved in a longitudinal direction, including a support device as claimed in claim 1, said support device being fixed to the back of the mechanical lift vehicle or to the side of the mechanical lift vehicle.

18. A mechanical lift including at least one mechanical lift vehicle as claimed in claim 17, said mechanical lift vehicle being of the chair or cabin type.
